(19) United States
(12) Patent Application Publication
(10) Pub. No.: US 2012/0038365 A1
(43) Pub. Date: Feb. 16, 2012

(54) LIQUID LEAKAGE PROPAGATION RESTRAINING STRUCTURE FOR ELECTRICITY STORAGE DEVICE AND BUS BAR MODULE

(76) Inventors: Shuichi Nagata, Aichi-ken (JP); Manabu Tsushima, Aichi-ken (JP); Shigenori Watanabe, Aichi-ken (JP); Takao Shoji, Aichi-ken (JP); Hikohito Yamazaki, Aichi-ken (JP); Tomohiro Ikeda, Shizuoka-ken (JP)

(21) Appl. No.: 13/265,551

(22) PCT Filed: Apr. 22, 2010
(86) PCT No.: PCT/IB10/00907

§ 371 Date: Oct. 21, 2011

(30) Foreign Application Priority Data
Apr. 23, 2009 (JP) 2009-105005

(51) Int. Cl. G01N 27/416

(52) U.S. Cl. 324/433

(57) ABSTRACT

In a liquid leakage propagation restraining structure, a voltage detection terminal that detects the voltage of an electricity storage device is connected to an electrode of the electricity storage device so that a crimp contact surface side of the voltage detection terminal to which an electric cable is crimped faces in the direction opposite the direction to the electrode. Therefore, the structure restrains the electrolytic solution that has leaked out and propagated to the electric cable from entering the interior of the core wire of the electric cable.

### BACKGROUND OF THE INVENTION

1. Field of the Invention

The invention relates to a liquid leakage propagation restraining structure for an electrolytic solution of an electricity storage device, such as a secondary battery or the like, and also relates to a bus bar module.

2. Description of the Related Art

As described in Japanese Patent Application Publication No. 2000-333343 (JP-A-2000-333343) (FIG. 7, FIG. 8, FIG. 14, etc.), in a battery, such as a secondary battery or the like, which is mounted in a hybrid motor vehicle or an electric motor vehicle, bus bar modules (battery connection modules) are attached to both sides of a battery assembly so as to connect in series a plurality of electric cells that constitute the battery assembly. The bus bar modules are formed from a synthetic resin or the like. Each bus bar module is provided with bus bars each of which electrically connects an electrode of an electric cell and an electrode of another electric cell, and with voltage detection terminals each of which is provided for detecting the voltage across one or more of the electric cells. The electrodes of the electric cells, the bus bars and the voltage detection terminals are fixed together by screwing nuts or the like. Each voltage detection terminal includes an electric contact portion that contacts the bus bar to detect the voltage of the electric cell, and a crimp contact portion to which an electric cable for outputting the voltage detected at the electric contact portion to a battery controller (not shown) is connected by crimping.

FIG. 6A is an enlarged sectional view of a connecting site between an electric cell and a bus bar module. As shown in FIG. 6A, one of two opposite end surfaces of a bus bar 21 is placed in contact with a battery electrode column 11 of an electric cell 10. The other one of the two opposite end surfaces of the bus bar 21 is in contact with an electric contact portion 22a of a voltage detection terminal 22. Then, a nut 23 is tightly screwed to a threaded portion 12 that is provided on the battery electrode column 11, so that the bus bar 21 and the voltage detection terminal 22 are tightly screwed and fixed to the battery electrode column 11.

FIG. 6B is a view of a bus bar module 20 seen from a direction of installation (the Y direction). Of the positive electrode P and the negative electrode N of each electric cell 10, the negative electrode N is provided with a voltage detection terminal 22. The bus bar module 20 has a wiring space S in which a crimp contact portion 22b of the voltage detection terminal 22 and an electric cable C are disposed.

Batteries, such as secondary batteries and the like, contain therein an electrolytic solution in a sealed manner. Depending on the reaction mechanism or rise in temperature, a creep phenomenon occurs, and the electrolytic solution sometimes leaks at an electrode to the outside. This sometimes results in a malfunction or the like due to the exposure of an electric cable or a voltage detection terminal of a bus bar module to the electrolytic solution, for example, a problem in the functions of the battery due to leakage of the electrolytic solution (liquid leakage) propagating to another electric component part via the electric cable, or due to leakage of the electrolytic solution moving at the core wire of the electric cable.

Furthermore, as for batteries, the countermeasure against leakage of the electrolytic solution is not sufficient. In particular, each of the foregoing voltage detection terminals 22 of the bus bar modules has a structure in which the crimp contact portion 22b of the voltage detection terminal 22 (in particular, the crimp contact surface side to which the core wire of the electric cable C is crimped in order to electrically connect the electric cable C and the electric contact portion 22a) faces the battery electrode column 11 side. In this structure, when the electrolytic solution leaks from the battery electrode column 11, and directly flows along the battery electrode column 11, and runs down to a lower side due to gravity, the electrolytic solution easily enters the crimp contact portion 22b. Therefore, the structure undesirably allows the leaking electrolytic solution to easily enter the core wire of the electric cable. Besides, the battery has a structure that allows leakage of the electrolytic solution to easily enter another electrical component part via the electric cable.

Besides, as described in the foregoing Japanese Patent Application Publication No. 2000-333343 (JP-A-2000-333343) (FIG. 7, FIG. 8, FIG. 14, etc.), each voltage detection terminal is provided at the negative electrode of the two battery electrodes. With regard to the enclosure of the electrolytic solution within batteries that contain an alkaline electrolytic solution, such as nickel metal hydride storage batteries (Ni-MH batteries), nickel cadmium storage batteries (Ni—Cd batteries), etc., leakage of the electrolytic solution is prevented by disposing a gasket made of rubber, Nylon® or the like within the battery jar of the positive or negative electrode terminal portion and applying a certain pressure thereto. However, it is known that the alkaline electric solution exhibits a creep phenomenon in which the electrolytic solution creeps on a metal surface, and therefore makes complete sealing very difficult. In particular, this phenomenon is known to be more likely to occur on the negative electrode than on the positive electrode. Therefore, in the case where a voltage detection terminal is connected to the negative electrode side, the distance that the electrolytic solution that leaks at the negative electrode propagates to the voltage detection terminal is short. Thus, in this case, there is provided a structure in which the electrolytic solution that leaks at the negative electrode is likely to be led to the voltage detection terminal.

Besides, as shown in FIG. 6B, the wiring space S (cutout formed in the bus bar module 20) formed in the synthetic resin-made bus bar module 20 in which the crimp contact portion 22b of the voltage detection terminal 22 and the electric wire C is to be disposed is formed so as to clamp the electric cable C. In the wiring space S, the crimp contact portion 22b of the voltage detection terminal 22 and the electric wire C are disposed without leaving a clearance in the longitudinal direction of the bus bar module 20. Therefore, in the case where the electrolytic solution leaks at a positive electrode P or a negative electrode N, and propagates to the crimp contact portion 22b of the adjacent voltage detection terminal, since there is no gap between walls of the wiring space S and the crimp contact portion 22b or the electric cable C, the leakage of the electrolytic solution has no exit from and accumulates in the vicinity of the crimp contact portion 22b of the voltage detection terminal 22, so that the electrolytic solution may enter the core wire of the electric cable C; and may propagate at the interior of the core wire of the electric cable C by capillary action.

Furthermore, since there is no clearance between the walls of the wiring space S and the crimp contact portion 22b or the electric cable C, a sealing material for stopping leakage of the electrolytic solution cannot be charged into the vicinity of the crimp contact portion 22b due to the absence of a space into which the sealing material is to be charged. Thus, the sealing against the liquid leakage cannot be carried out.

### SUMMARY OF THE INVENTION

The invention relates to a liquid leakage propagation restraining structure for an electricity storage device which restrains leakage of an electrolytic solution of an electricity storage device from flowing out along an electric cable and from propagating at the interior of core wire of an electric cable by capillary action, and a bus bar module.

A first aspect of the invention relates to a liquid leakage propagation restraining structure for an electricity storage device that includes an electrolytic solution. The liquid leakage propagation restraining structure includes: a voltage detection terminal provided that detects voltage of the electricity storage device; and an electrode that belongs to the electricity storage device. The voltage detection terminal is connected to the electrode so that a crimp contact surface side of a crimp contact portion of the voltage detection terminal to which an electric cable is crimped faces in a direction opposite a direction to the electrode of the electricity storage device.

In the first aspect, a sealing material that adsorbs or absorbs the electrolytic solution that leaks at the electrode may be provided within the electric cable.

In the first aspect, the voltage detection terminal may be electrically connected to the electrode that is on a positive electrode side of the electricity storage device.

In the first aspect, the liquid leakage propagation restraining structure may further include a bus bar module that electrically connects a plurality of electricity storage elements that constitute the electricity storage device. The bus bar module may include a bus bar that electrically connects the electrode of one of the electricity storage elements and the electrode of another one of the electricity storage elements. The electric cable of the voltage detection terminal that detects the voltage of at least one of the electricity storage elements that is connected to the bus bar may be crimped to the crimp contact portion. A sealing material fill-in portion and/or a sump portion for the electrolytic solution that leaks at the electrode may be formed in a wiring space that houses the electric cable.

In the first aspect, a width of the wiring space in a longitudinal direction of the bus bar module may be a length that includes a diameter of the electric cable and gaps that are provided at two opposite sides of the electric cable.

In the first aspect, the sump portion and/or the sealing material fill-in portion may be provided at least one of two opposite sides of the electric cable.

In the first aspect, the sump portion and/or the sealing material fill-in portion may be the sealing material fill-in portion. Both the sealing material fill-in portion and the wiring space may be filled with a sealing material.

In the first aspect, the crimp contact portion may be sealed.

In the first aspect, the crimp contact portion may be sealed by soldering.

In the first aspect, the crimp contact portion may be provided above the electrode.

A second aspect of the invention relates to a liquid leakage propagation restraining structure for an electricity storage device that includes an electrolytic solution. The liquid leakage propagation restraining structure includes: a voltage detection terminal that detects voltage of the electricity storage device; and an electrode that belongs to the electricity storage device. The voltage detection terminal is electrically connected to a positive electrode side of the electrode.

In the second aspect, a crimp contact portion of the voltage detection terminal to which an electric cable is crimped may be provided above the electrode.

A third aspect of the invention relates to a bus bar module electrically connects a plurality of electricity storage elements that includes an electrolytic solution and that constitute an electricity storage assembly. The bus bar module includes: a bus bar that electrically connects an electrode of one of the electricity storage elements and an electrode of another one of the electricity storage elements; and a crimp contact portion to which an electric cable of a voltage detection terminal, that detects voltage of one or more of the electricity storage elements, is crimped, and that is connected to the bus bar; and/or a sealing material fill-in portion and/or a sump portion for the electrolytic solution that leaks at the electrode in a wiring space that houses the electric cable.

In the third aspect, a width of the wiring space in a longitudinal direction of the bus bar module may be a length that includes a diameter of the electric cable and gaps that are provided at two opposite sides of the electric cable.

In the third aspect, the sump portion and/or the sealing material fill-in portion may be provided at least one of two opposite sides of the electric cable.

In the third aspect, the sump portion and/or the sealing material fill-in portion may be the sealing material fill-in portion. Both the sealing material fill-in portion and the wiring space may be filled with a sealing material.

A fourth aspect of the invention relates to a liquid leakage propagation restraining structure for an electricity storage device that includes an electrolytic solution. The liquid leakage propagation restraining structure includes a crimp contact portion of a voltage detection terminal that detects voltage of the electricity storage device. The crimp contact portion is sealed.

In the fourth aspect, the crimp contact portion may be sealed by soldering.

According to the first aspect, since the voltage detection terminal is connected to an adjacent one of the electrodes of the electricity storage device so that the crimp contact surface of the voltage detection terminal to which an electric cable is crimped faces in the direction opposite the direction to the electrode, it is possible to restrain the electrolytic solution that leaks at the electrode from entering the core wire of the electric cable via the electric cable.

According to the second aspect; since the voltage detection terminal is electrically connected to the electrode that is on the positive electrode side of the electricity storage device, it is possible to make it less likely that leakage of the electrolytic solution from the negative electrode side propagates to the voltage detection terminal by the negative electrode creep phenomenon in batteries that use an alkaline electrolytic solution, such as nickel metal hydride storage batteries (Ni-MH batteries), nickel cadmium storage batteries (Ni—Cd batteries), etc.

According to the third aspect, since the sump portion (gap) is provided in the wiring space in which the electric cable and/or the crimp contact portion of the voltage detection terminal in the bus bar module is disposed, a clearance is given between the wall of the wiring space and the crimp contact portion and/or the electric cable, so that the electrolytic solution that leaks is less likely to propagate to the voltage detection terminal. Besides, the sump portion serves as a sealing material fill-in space into which the sealing material is to be charged or placed. Therefore, it is possible to take a countermeasure against leakage of the electrolytic solution at the use of a sealing material.

According to the fourth aspect, since the crimp contact portion of the voltage detection terminal (to which the electric cable is crimped) is sealed, entrance of the electrolytic solution into the interior of the core wire of the electric cable (the voltage detection line) can be restrained even in the case where the electrolytic solution has reached the crimp contact portion. Incidentally, while the crimp contact portion can be sealed by soldering, this is not restrictive. For example, adhesive and other sealing materials can be used. Due to this, it becomes less likely that the electrolytic solution that leaks propagates to other electric component parts.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is an exploded perspective view of an electricity storage device in a first embodiment of the invention;

FIG. 2A is an enlarged sectional view of a connecting site between a battery electrode and a bus bar module for illustrating a configuration of the connection of the bus bar module of an electricity storage device in the first embodiment of the invention;

FIG. 2B is a front view of the bus bar module for illustrating the connecting configuration of the bus bar module of the electricity storage device in the first embodiment of the invention;

FIG. 3A is a diagram illustrating soldering connection of a voltage detection terminal in a second embodiment of the invention;

FIG. 3B is a perspective view of a voltage detection terminal in the second embodiment of the invention;

FIG. 3C is a sectional view of an electric cable which illustrates the voltage detection terminal in the second embodiment of the invention;

FIG. 4A and FIG. 4B are diagrams for illustrating a first modification in the invention;

FIG. 5 is a diagram for illustrating a second modification in the invention;

FIG. 6A is an enlarged sectional view of a connecting site between a battery electrode and a bus bar module, illustrating a configuration of connection of a related-art bus bar module; and

FIG. 6B is a front view of a bus bar module illustrating a configuration of connection of a related-art bus bar module.

### DETAILED DESCRIPTION OF EMBODIMENTS

Hereinafter, embodiments of the invention will be described.

### First Embodiment

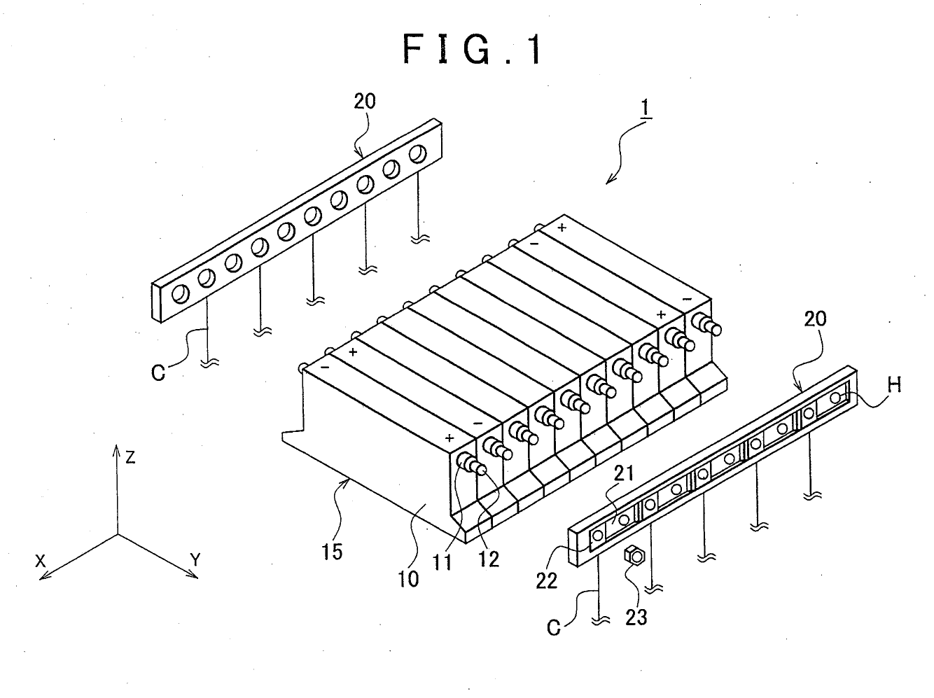

FIG. 1 is an exploded perspective view of an electricity storage device 1 to which the liquid leakage propagation restraining structure and the bus bar module of the invention are applied. The electricity storage device 1 includes a battery assembly (electricity storage assembly) 15 constructed of a plurality of electric cells 10, and bus bar modules 20 that electrically connect positive electrodes P (+) and negative electrodes N (−) of the electric cells 10 and that connects the electric cells of the entire battery assembly 15 in series.

The electricity storage device 1 is used as an electric power supply device mounted in a hybrid vehicle or an electric motor vehicle, such as a secondary battery that uses an alkaline electrolytic solution, including a nickel metal hydride storage battery (Ni-MH battery), a nickel cadmium storage battery (Ni—Cd battery), etc., a lithium ion secondary battery, an electric double layer capacitor, etc. Each electric cell 10 contains therein an electrolytic solution, and is provided with a positive electrode P and a negative electrode N that are protruded in a left-right direction Y of the battery assembly 15 (a left-right direction Y of the electric cell which is orthogonal to a stacking direction X of the electric cells 10).

The bus bar module 20 is a resin case that is formed from a synthetic resin or the like, and includes a plurality of bus bars 21. Each bus bar 21 is formed from a metal so as to electrically connect different electrodes of two adjacent electric cells 10, that is, the positive electrode P of one of two adjacent electric cells 10 and the negative electrode N of the other electric cell 10. The bus bar 21 has an insertion hole H at which a threaded portion 12 of a battery electrode column 11 that is provided on each of the electrodes of each electric cell. Then, the bus bar modules 20 are provided on the left and right sides (two side surfaces) of the battery assembly 15 so as to connect the electric cells 10 of the entire battery assembly 15 in series. That is, the number of the bus bar modules 20 provided is two. The bus bar modules 20 (the bus bars 21) connect the electric cells of the battery assembly 15 in series when the threaded portions 12 of the battery electrode columns 11 are inserted at the insert holes H of the bus bars 21.

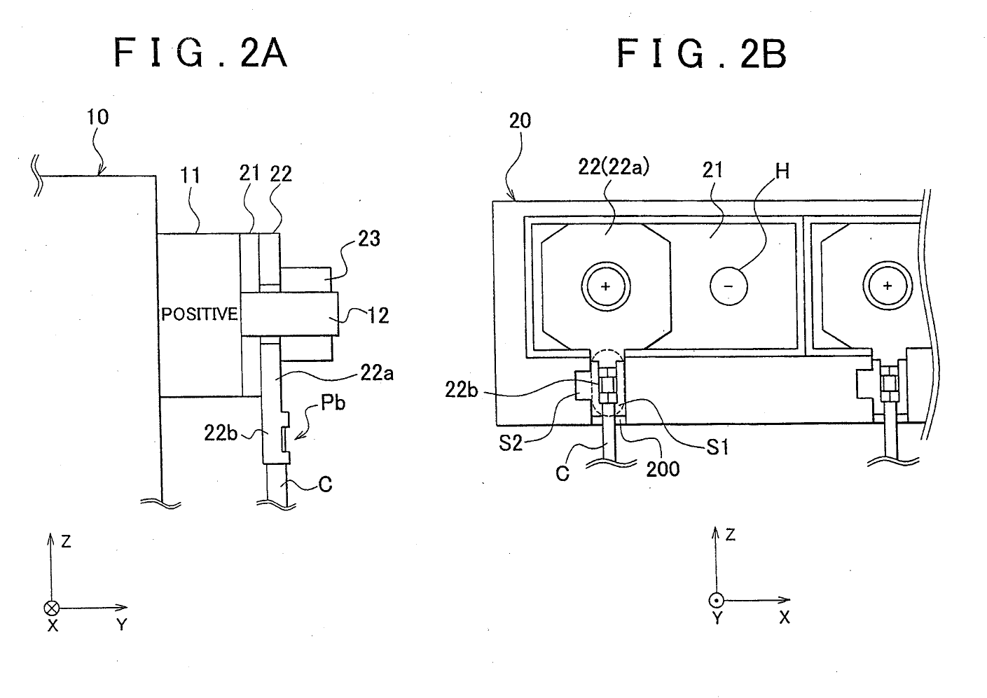

Besides, each bus bar 21 is provided with a voltage detection terminal 22 for detecting the voltage of one or more electric cells 10. Each bus bar module 20 has a holding mechanism (not shown) that holds a voltage detection terminal 22, and a wiring space S1 for an electric cable (voltage detection cable) C that is connected to the voltage detection terminal 22 (see FIG. 2B).

Hereinafter, with reference to FIG. 2A and FIG. 2B, the bus bar modules 20 of this embodiment, and a voltage detection terminal 22 and its structure will be described in detail.

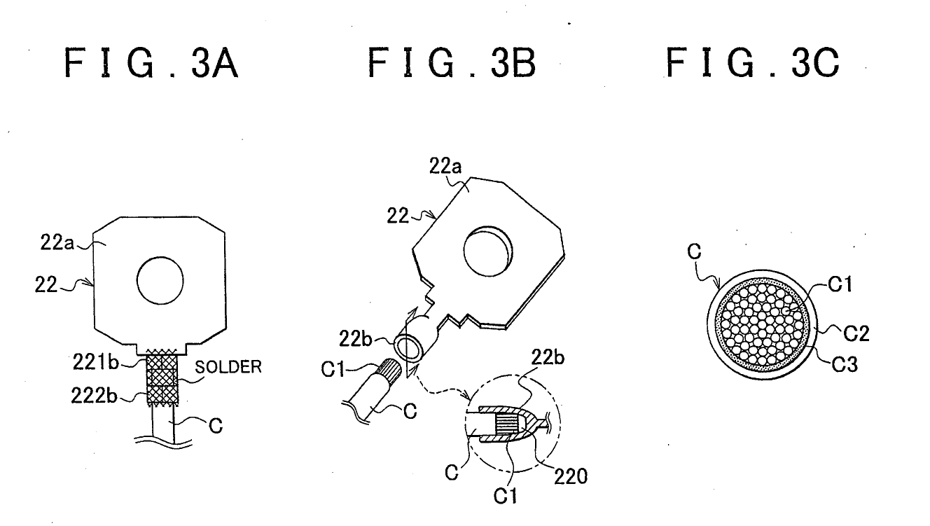

As shown in FIG. 2A and FIG. 2B, the voltage detection terminal 22 includes an electric contact portion 22a that electrically contacts the bus bar 21 to detect the voltage of one or more electric cells 10, and a crimp contact portion 22b to which an electric cable C for outputting to a battery controller (not shown) the voltage detected at the electric contact portion 22a is connected by crimping. The electric cable C is constructed of core wire C1 made of copper or the like, and a coat member C2 that coats the core wire C1, The electric cable C, specifically, the core wire C1 exposed, is connected by crimping to the crimp contact portion 22b, and is thus electrically connected to the voltage detection terminal 22 (see FIG. 3C).

Each of the wiring spaces S1 of the bus bar module 20 (cutouts formed in the bus bar module 20) is formed so as to provide a gap between the wall surface of the wiring space S1 of the bus bar module 20 and a unit of the crimp contact portion 22b of the voltage detection terminal 22 and the electric cable C adjacent to the crimp contact portion 22b (in FIG. 2B, at two opposite sides of the unit of the crimp contact portion 22b and the electric cable C combined). At least the crimp contact portion 22b and the electric cable C adjacent to the crimp contact portion 22b are out of contact with the cut-out portion of the bus bar module 20. A portion of the electric cable C that is apart from the crimp contact portion 22b is held by a holder portion 200 of the bus bar module 20.

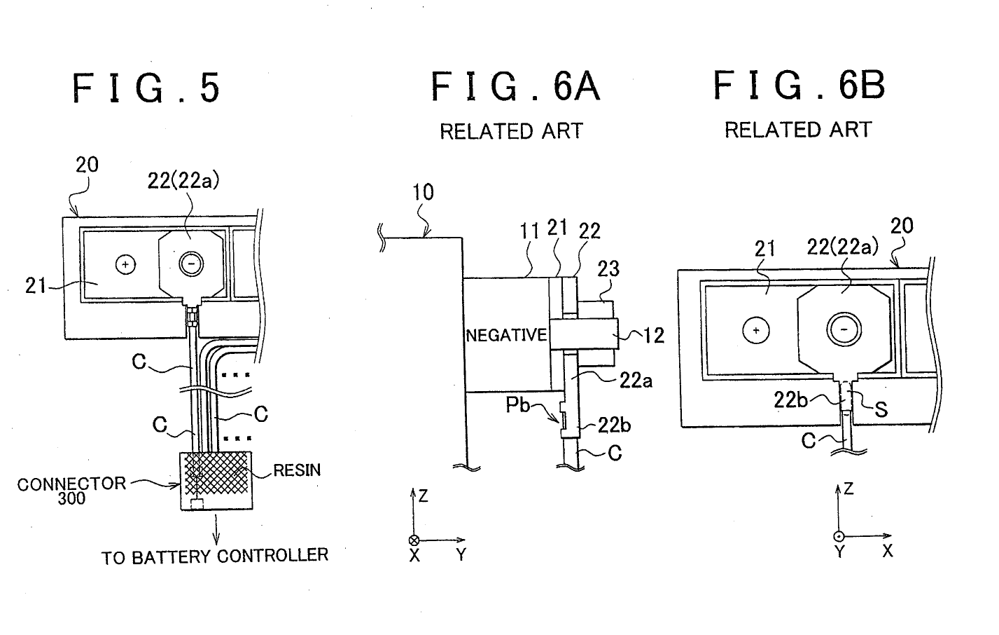

That is, unlike a related-art bus bar module (see FIG. 6A and FIG. 6B) in which a crimp contact portion 22b and an electric cable C are clamped in a wiring space S and no gap is formed between the crimp contact portion 22b and/or the electric cable C and the wall surface of a cut-out portion formed in the bus bar module 20, the bus bar module 20 of this embodiment has a wiring space S1 in which a voltage detection terminal 22 can be disposed and which includes a gap between the cut-out portion of the bus bar module 20 and a unit of the crimp contact portion 22b of the voltage detection terminal 22 and the electric cable C adjacent to the crimp contact portion 22b.

Besides, in the vicinity of the crimp contact portion 22b, a sump portion S2 is linked to the wiring space S1. That is, a cross-sectional area of the space combining the wiring space S1 and the sump portion S2 taken on the X-Y plane at (see FIG. 2B) is larger than the cross-sectional area of the wiring space S1. This sump portion S2 is provided with a sealing material fill-in opening (not shown) for charging, from outside the bus bar module 20, a sealing material that adsorbs/absorbs the electrolytic solution. The sealing material can be charged in at the sealing material fill-in opening. The sealing material, when charged in, fills the space that is formed by the wiring space S1 and the sump portion S2, and adsorbs/absorbs a leakage of the electrolytic solution that propagates to the crimp contact portion 22b of the voltage detection terminal 22. Incidentally, it suffices for the sealing material to be capable of absorption or the like of the electrolytic solution. The sealing material may be, for example, a sheet or a powder of a water-absorbing polymer.

As described above, as for a battery, such as a secondary battery or the like, the electrolytic solution sealed within the battery sometimes leaks at an electrode to the outside of an electric cell by a creep phenomenon that occurs depending on the reaction mechanism or rise in temperature. As shown in FIG. 1, the electric cable C and the crimp contact portion 22b of each voltage detection terminal 22 are positioned below the battery electrode column 11, which is subject to liquid leakage. Therefore, the electrolytic solution that leaks from a battery electrode column 11 immediately flows along the battery electrode column 11, and runs down to a lower side due to gravity so that the electrolytic solution is led to the voltage detection terminal 22. That is, in the case where the battery electrode columns 11 are protruded in the left-right direction of the battery assembly 15 (in the Y direction), the bus bar modules 20 are disposed on the left and right side surfaces of the battery assembly 15. Therefore, in the positional relation in the Z direction between the battery electrode columns 11 and the voltage detection terminals 22 on the left and right side surfaces of the battery assembly 15, the voltage detection terminals 22 are positioned below the battery electrode columns 11, which are subject to liquid leakage. Therefore, there is provided a structure in which the electrolytic solution that leaks from any one of the battery electrode columns 11 positioned on the left and right side surfaces of the electric cell 10 is easily led to the crimp contact portion 22b and the electric cable C of the adjacent voltage detection terminal 22.

Therefore, in this embodiment, the voltage detection terminal 22 of the bus bar module 20 is connected by screwing to the battery electrode column 11, together with the bus bar 21, so that the crimp contact surface Pb of the crimp contact portion 22b of the voltage detection terminal 22 to which the core wire portion of the electric cable C is crimped in order to electrically connect the electric contact portion 22a faces in a direction opposite the direction to the battery electrode column 11 (electrode) as shown in FIG. 2A, unlike the related-art technology shown in FIG. 6A in which the crimp contact surface Pb of the crimp contact portion 22b of the voltage detection terminal 22 is disposed facing the battery electrode column 11 side.

That is, the crimp contact surface Pb is a surface on which the core wire of the electric cable C that is deprived of a coat member is electrically connected by crimping to the voltage detection terminal 22. Concretely, the voltage detection terminal 22 is provided on the battery electrode column 11 (electrode) so that a side of the crimp contact portion 22b on which the core wire of the electric cable C is mounted faces in the direction opposite the direction to the battery electrode column 11 (is not exposed to the battery electrode column side). That is, the voltage detection terminal 22 is disposed so that the opposite side of the crimp contact portion 22b from the crimp contact surface Pb thereof faces the battery electrode column 11 side.

Therefore, even if the electrolytic solution that leaks at the battery electrode column 11 immediately flows along the battery electrode column 11, and runs down to a lower side due to gravity, and propagates to the voltage detection terminal 22, the contact of leakage of the electrolytic solution with the core wire of the electric cable C can be avoided or restrained because the electrolytic solution propagates along the surface of the opposite side of the crimp contact portion 22b from the crimp contact surface Pb thereof. Furthermore, the propagation of leakage of the electrolytic solution in which the electrolytic solution enters the interior of the core wire of the electric cable C and advances by capillary action can be restrained.

Besides, each voltage detection terminal 22 in this embodiment is disposed only on a positive electrode P-side portion of a bus bar that connects a positive electrode P and a negative electrode N, and is connected to the positive electrode P-side portion of the bus bar by screwing. In batteries that use an alkaline electrolytic solution, such as nickel metal hydride storage batteries (Ni-MH batteries), nickel cadmium storage batteries (Ni—Cd batteries), etc., it is known that the electrolytic solution is liable to leak from the negative electrode N-side by creep phenomenon. Therefore, connecting the voltage detection terminal 22 to the positive electrode P-side increases the distance that the electrolytic solution that leaks at the negative electrode N propagates to the voltage detection terminal 22. This makes a structure in which the electrolytic solution that leaks at the negative electrode N-side is not easily led to the voltage detection terminal 22.

Furthermore, as shown in FIG. 2B, in each of the bus bar modules 20 formed from a synthetic resin, each wiring space S1 for the electric cable C and the crimp contact portion 22b of a voltage detection terminal 22 is constructed so that a clearance is provided between the wall surface of the wiring space S1 and the unit of the crimp contact portion 22b and the electric cable C combined. Therefore, even in the case where the electrolytic solution leaks at the positive electrode P or the negative electrode N and propagates to the crimp contact portion 22b of the voltage detection terminal 22, the leakage of the electrolytic solution does not reside on or near the voltage detection terminal 22, but propagates downward at the gap between the electric cable C and the wall of the wiring space S1. This restrains leakage of the electrolytic solution from entering the core wire of the electric cable C and therefore from propagating inside the core wire by capillary action.

Besides, as shown in FIG. 2B, the sump portion S2 is linked to the wiring space S1. Hence, due to the wiring space S1 and the sump portion S2, a sealing material fill-in space into which a sealing material is to be charged in order to block leakage of the electrolytic solution is secured between the wall of the wiring space S1 and the sump portion S2 combined and the unit of the crimp contact portion 22b and the electric cable C combined. Hence, the sealing against the leakage near the crimp contact portion 22b can be carried out.

### Second Embodiment

FIGS. 3A to 3C are diagrams illustrating the voltage detection terminal 22 in a second embodiment. FIG. 3A is a diagram illustrating the soldering connection of the voltage detection terminal 22. FIG. 3B is a perspective view of the voltage detection terminal 22. FIG. 3C is a cross-sectional view of an electric cable.

In the voltage detection terminal 22 in this embodiment, a crimp contact leg portion 221b (front leg) and another crimp contact leg portion 222b (rear leg) are entirely covered and sealed with solder (indicated by hatching in FIG. 3A), so that leakage of the electrolytic solution will not enter the core wire of the electric cable C. That is, generally in the related art, the electric cable C is connected by crimping to the crimp contact portion 22b via the crimp contact leg portions 221b and 222b, and the crimp contact leg portion 221b that is near the electric contact portion 22a is soldered (i.e., only a portion to which exposed core wire C1 is electrically connected is soldered). In this embodiment, the soldering is performed so as to cover the entire crimp contact portion 22b that includes the crimp contact leg portion 222b as well, so that the entrance of leakage of the electrolytic solution into the interior of the core wire. C1 of the electric cable C can be restrained. Incidentally, besides solder, adhesive or other sealing materials may also be used to seal the crimp contact portion 22b.

Besides, as shown in FIG. 3B, it is also possible to use a voltage detection terminal 220 in which the crimp contact portion 22b to which exposed core wire C1 of the electric cable C is electrically connected has an umbrella shape. Concretely, instead of a construction in which the electric cable C is connected in a crimping manner via the two crimp contact leg portions 221b and 222b as shown in FIG. 3A, the crimp contact portion 22b has a tubular hole portion 220 which accepts insertion of the uncoated core wire C1 of the electric cable C shown in FIGS. 3B and 3C and which has an umbrella shape in which an electric contact portion 22a-side portion of the hole portion 220 is closed. Therefore, the electric cable C can be connected by crimping without the core wire C1 thereof being exposed from the crimp contact portion 22b, so that leakage of the electrolytic solution can be restrained from entering the interior of the core wire C1 of the electric cable C from the crimp contact portion 22b. Besides, the labor (labour) for an operation, such as soldering or the like, can be omitted.

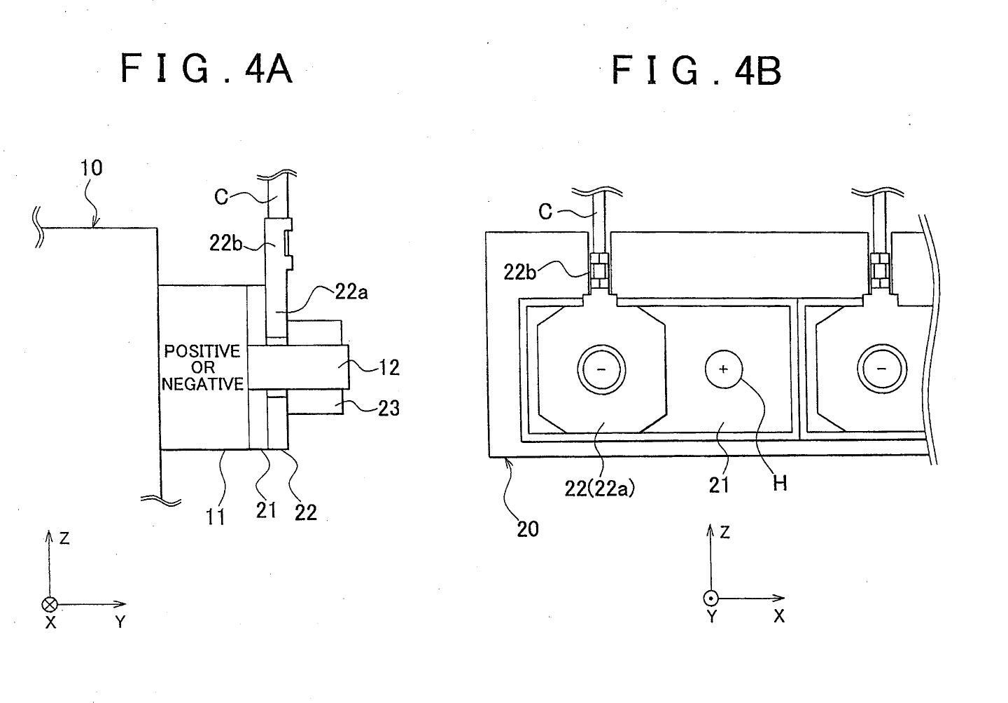

FIG. 3C is a diagram showing a configuration in which a gap between the core wire C1 and the coat member C2 of the electric cable C is filled with a sealing material C3. In this configuration, the leakage of the electrolytic solution entering the interior of the core wire C1 is adsorbed/absorbed by the sealing material C3. Therefore, even if leakage of the electrolytic solution enters the interior of the core wire C1 of the electric cable C, the propagation of the electrolytic solution by capillary action can be restrained.

[Modifications] FIGS. 4A and 4B are diagrams showing a first modification of the first embodiment. In this modification, since the electrolytic solution that leaks at any one of the electrodes disposed on the left and right sides of the battery assembly 15 is led to a lower portion of the battery assembly 15 due to gravity as mentioned above, voltage detection terminals 22 are disposed as determined by bus bar modules 20 that are each formed so that the crimp contact portion 22 of each voltage detection terminal 22 is positioned above the adjacent electrode (battery electrode column 11) in the direction Z of the battery assembly 15. Due to this construction, in the case where the electrolytic solution leaks at any one of the positive electrodes P or the negative electrodes N and is led to a lower side by gravity, the electrolytic solution does not propagate to the crimp contact portion 22b or to the electric cable C because the crimp contact portion 22b is positioned above the leaking electrode. Thus, propagation of leakage of the electrolytic solution can be restrained. Furthermore, since the crimp contact portions 22b and the electric cables C do not contact the electrolytic solution, the corrosion and the like of the crimp contact portions 22b and the electric cables C can be restrained.

FIG. 5 is a diagram showing a second modification in which a plurality of electric cables C extending from voltage detection terminals 22 that are disposed on a bus bar module 20 are collectively connected to a connector 300. Besides, the electric cables C from the voltage detection terminals 22 are connected to a battery controller (not shown), and the voltage detection signals detected by the voltage detection terminals 22 are input to the battery controller. In this arrangement, the connector 300 is provided for connecting the battery controller and the electric cables C, and the electric cables C are connected to the battery controller via the connector 300.

It is to be noted herein that capillary action does not occur, if one of the two end portions of an electric cable C is closed. Therefore, in order to substantially prevent the advance of leakage of the electrolytic solution at the interior of the core wire of any one of the electric cables C, one of the two ends of each electric cable C is closed to the outside or to the outside air so as to prevent entrance of air or the like into the interior of the electric cable C. In the second modification, the connector 30 connected to the battery controller (not shown) is subjected to a sealing process for the electric cables C, whereby the electrolytic solution that advances from any crimp contact portion 22b into the core wire inside the electric cable C is restrained from being propagated by capillary action.

Concretely, a region of the connector 300 that includes end portions of the electric cables C (a region indicated by hatching in FIG. 5) is subjected to a potting process in which resin or the like is enclosed in an interior of the connector 300 in which the end portions of the electric cables C are disposed. Thus, air or the like will not enter the interior of any one of the electric cables C.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A liquid leakage propagation restraining structure for an electricity storage device that includes an electrolytic solution, by comprising:
a voltage detection terminal that detects voltage of the electricity storage device;
an electrode that belongs to the electricity storage device; and
a bus bar module that electrically connects a plurality of electricity storage elements that constitute the electricity storage device,
wherein the voltage detection terminal is connected to the electrode so that a crimp contact surface side of a crimp contact portion of the voltage detection terminal to which an electric cable is crimped faces in a direction opposite to the electrode of the electricity storage device,
wherein the bus bar module includes a bus bar that electrically connects the electrode of one of the electricity storage elements and the electrode of another one of the electricity storage elements,
wherein the electric cable of the voltage detection terminal that detects the voltage of at least one of the electricity storage elements that is connected to the bus bar is crimped to the crimp contact portion, and
wherein sealing material fill-in portion and/or a sump portion for the electrolytic solution that leaks at the electrode is formed in a wiring space that houses the electric cable.

2. The liquid leakage propagation restraining structure according to claim 1, wherein a sealing material that adsorbs or absorbs the electrolytic solution that leaks at the electrode is provided within the electric cable.

3. The liquid leakage propagation restraining structure according to claim 1, wherein the voltage detection terminal is electrically connected to the electrode that is on a positive electrode side of the electricity storage device.

4. (canceled)

5. The liquid leakage propagation restraining structure according to claim 1, wherein a width of the wiring space in a longitudinal direction of the bus bar module is a length that includes a diameter of the electric cable and gaps that are provided at two opposite sides of the electric cable.

6. The liquid leakage propagation restraining structure according to claim 1, wherein the sump portion and/or the sealing material fill-in portion is provided at least one of two opposite sides of the electric cable.

7. The liquid leakage propagation restraining structure according to claim 1, wherein:
the sump portion and/or the sealing material fill-in portion is the sealing material fill-in portion; and
both the sealing material fill-in portion and the wiring space are filled with a sealing material.

8. The liquid leakage propagation restraining structure according to claim 1, wherein the crimp contact portion is sealed.

9. The liquid leakage propagation restraining structure according to claim 8, wherein the crimp contact portion is sealed by soldering.

10. The liquid leakage propagation restraining structure according to claim 1, wherein the crimp contact portion is provided above the electrode.

11. A liquid leakage propagation restraining structure for an electricity storage device that includes an electrolytic solution, comprising:
a voltage detection terminal that detects voltage of the electricity storage device; and
an electrode that belongs to the electricity storage device,
wherein the voltage detection terminal is electrically connected to a positive electrode side of the electrode,
wherein a crimp contact portion of the voltage detection terminal to which an electric cable is crimped is provided above the electrode, and
wherein the above direction is defined as an upward direction when the electricity storage device is being used.

12. (canceled)

13. A bus bar module that electrically connects a plurality of electricity storage elements that includes an electrolytic solution and that constitute an electricity storage assembly, comprising:
a bus bar that electrically connects an electrode of one of the electricity storage elements and an electrode of another one of the electricity storage elements;
a crimp contact portion to which an electric cable of a voltage detection terminal, that detects voltage of one or more of the electricity storage elements, is crimped, and that is connected to the bus bar; and
sealing material fill-in portion and/or a sump portion for the electrolytic solution that leaks at the electrode in a wiring space that houses the electric cable.

14. The bus bar module according to claim 13, wherein a width of the wiring space in a longitudinal direction of the bus bar module is a length that includes a diameter of the electric cable and gaps that are provided at two opposite sides of the electric cable.

15. The bus bar module according to claim 13, wherein the sump portion and/or the sealing material fill-in portion is provided at least one of two opposite sides of the electric cable.

16. The bus bar module according to claim 13, wherein:
the sump portion and/or the sealing material fill-in portion is the sealing material fill-in portion; and
both the sealing material fill-in portion and the wiring space are filled with a sealing material.

17. (canceled)

18. (canceled)
